(19) United States
(12) Patent Application Publication
(10) Pub. No.: US 2026/0218841 A1
(43) Pub. Date: Jul. 30, 2026

(54) DESKTOP DISPLAY STAND

(71) Applicant: Jolly Innovation Technology Co., Ltd., Guangzhou (CN)

(72) Inventor: Li Xiao, Guangzhou (CN)

(21) Appl. No.: 19/454,699

(22) Filed: Jan. 21, 2026

(30) Foreign Application Priority Data
Jan. 27, 2025 (CN) 202520177719.6

(51) Int. Cl. F16M 11/04; F16M 11/22

(52) U.S. Cl. CPC F16M 11/046; F16M 11/22; F16M 2200/08

(57) ABSTRACT

The present disclosure provides a desktop display stand, the desktop display stand including a pair of stand legs, and the pair of stand legs including a first stand leg and a second stand leg arranged symmetrically, one of the first stand leg and the second stand leg including a connecting member configured to support a display and a support member attached to the connecting member, wherein the support member includes an elongate base plate configured to contact with a supporting surface, the elongate base plate extends along a first direction, and the first directions of the elongate base plates of the first stand leg and the second stand leg intersect with each other.

### RELATED APPLICATIONS

This application claims the benefit of priority to Chinese Patent Application Number 202520177719.6 filed on Jan. 27, 2025, in the China National Intellectual Property Administration. The entire contents of the above-identified application are hereby incorporated by reference.

### TECHNICAL FIELD

The present disclosure relates to the technical field of a supporting mechanism for displays, and in particular, to a desktop display stand.

### BACKGROUND

With the improvement of living standards, large-sized displays, such as liquid crystal displays, OLED displays and so on, have emerged. In order to support the large-sized displays on a desktop, display stands have been developed accordingly. The display stands attach to a rear surface of the large-sized displays and support the display to be placed on the desktop. However, as the size of the display increases, the requirement for the stability of the stand becomes increasingly higher.

### BRIEF DESCRIPTION OF DRAWINGS

In order to illustrate the technical solution in embodiments of the present invention more clearly, the following briefly introduces accompanying drawings used in the description of the embodiments. Obviously, the accompanying drawings in the following description are only some embodiments of the present invention. Those of ordinary skill in the art can obtain other accompanying drawings from these accompanying drawings without any creative efforts.

FIG. 1 is a perspective view of a desktop display stand attached to a display according to a first embodiment of the present disclosure.

FIG. 2 is a perspective view of the desktop display stand shown in FIG. 1. The desktop display stand includes a pair of stand legs, which include a first stand leg and a second stand leg in an embodiment of the present disclosure.

FIG. 3 is a perspective view of the first stand leg of the desktop display stand shown in FIG. 2. The first stand leg includes a first support leg, a first support bracket, and a support foot in an embodiment of the present disclosure.

FIG. 4 is a perspective view of the first support leg of the first stand leg shown in FIG. 3.

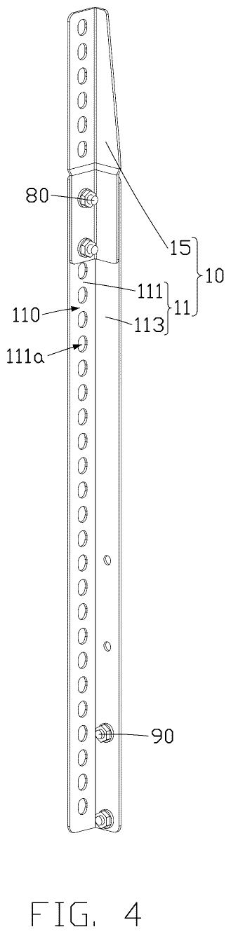

FIG. 5 is an exploded view of the first stand leg shown in FIG. 3.

FIG. 6 is an exploded view of the first stand leg shown in FIG. 3, viewed from another viewing direction.

FIG. 7 is a cross-sectional view of an assembly structure of the first support leg and the first support bracket shown in FIG. 3 in an embodiment of the present disclosure.

FIG. 8 is a perspective view of the first support leg of the desktop display stand according to a second embodiment of the present disclosure, with the protective cover being omitted.

FIG. 9 is a perspective view of the first support leg of the desktop display stand according to a third embodiment of the present disclosure, with the protective cover being omitted.

FIG. 10 is a perspective view of the first support leg of the desktop display stand according to a fourth embodiment of the present disclosure, with the protective cover being omitted.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

### First Embodiment

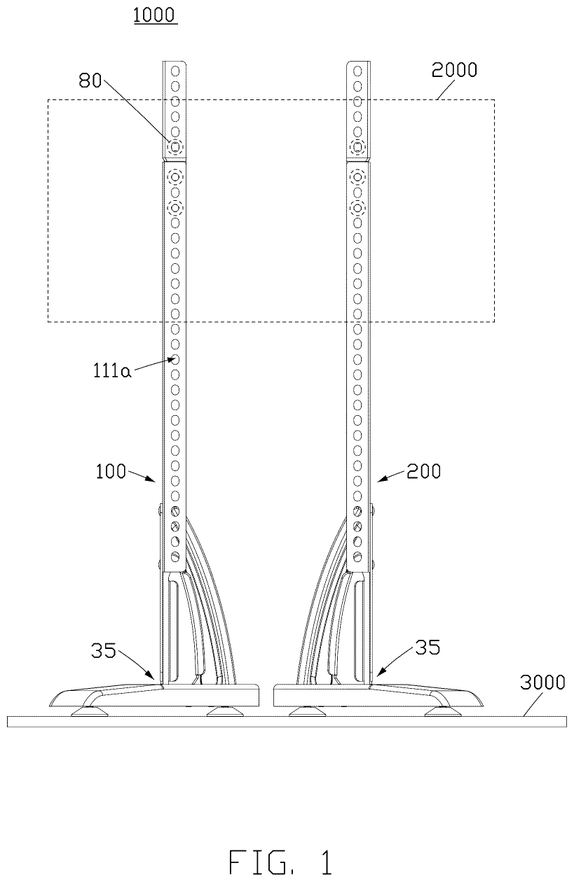

As shown in FIG. 1, a first embodiment of the present disclosure provides a desktop display stand 1000 for mounting different sizes of displays 2000. The desktop display stand 1000 includes two stand legs, which have a same structure and cooperate with each other to connect to a rear surface of the display 2000. Each of the two stand legs includes a base plate 35 to support on an external supporting element 3000, such as a desktop 3000. When the desktop display stand 1000 is attached to the rear surface of the display 2000, the base plates 35 of the two stand legs are naturally arranged in an open V shape on the external supporting element 3000 due to the stand's structural design. Therefore, compared to a traditional stand leg having two standing feet naturally arranged parallel to each other, a supporting area enclosed by the two base plates 35 is expanded, allowing the display 2000 to be more stably supported on the desktop 3000 without wobbling even when subjected to external forces. In some embodiments of the present disclosure, the display 2000 may be a monitor, for example, a television monitor or a computer monitor.

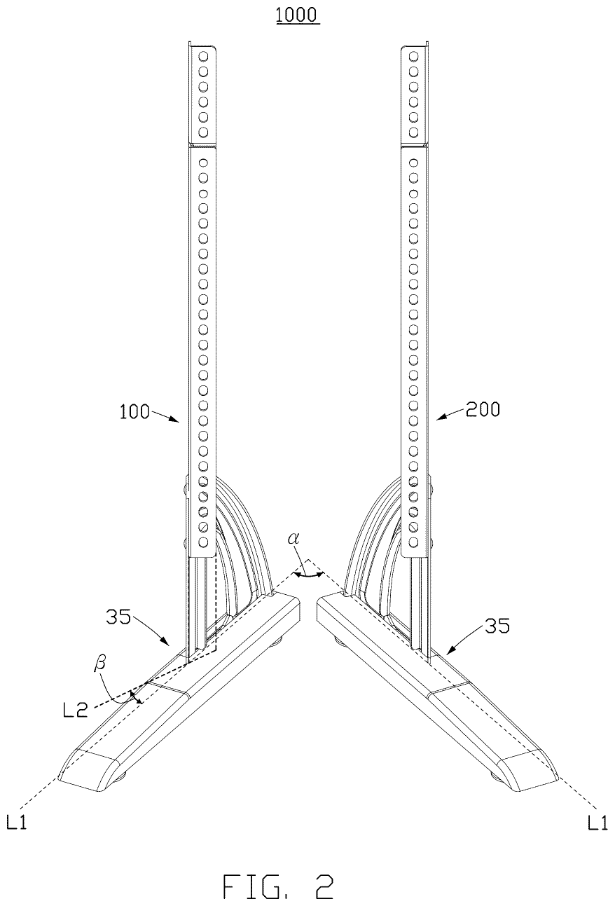

As shown in FIG. 2, the desktop display stand 1000 includes a first stand leg 100 and a second stand leg 200 which are arranged symmetrically along an axis of symmetry. The first stand leg 100 and the second stand leg 200 are arranged side by side and spaced apart on the desktop 3000, and jointly attach to the rear surface of the display 2000, thereby supporting the display 2000 on the desktop 3000. The second stand leg 200 has the same structure as the first stand leg 100, so that only the structure of the first stand leg 100 will be described in detail.

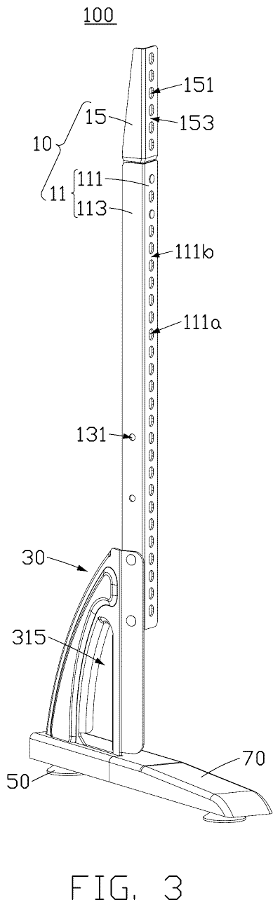

Referring to FIG. 3, the first stand leg 100 includes a first support leg 10, a first support bracket 30, and a support foot 50. The first support leg 10 is attached and fixed to the rear surface of the display 2000 so as to connect to the display 2000. The first support bracket 30 is configured to support the first support leg 10, and a top end of the first support bracket 30 is detachably connected to the first support leg 10. The support foot 50 is located at a bottom end of the first support bracket 30 and has two opposite sides, one side of the support foot 50 detachably connects to the base plate 35 of the first support bracket 30 and another side of the support foot 50 is in contact with the desktop 3000 to stably place the display 2000 on the desktop 3000.

The first support leg 10 extends along a length direction parallel to a height direction of the display 2000. A cross section of the first support leg 10 has an L-shaped structure, a bottom end of the first support leg 10 detachably connects to the top side of the first support bracket 30, and the first support leg 10 is positioned in the rear surface of the display 2000 and configured to attach to the display 2000.

A height between the display 2000 and the desktop 3000 can be adjusted via the first support leg 10. The first support leg 10 includes a mounting member 11 and an extending member 15 detachably connected to the mounting member 11. At least a portion of the extending member 15 has a same structure as the mounting member 11. The extending member 15 is configured to lengthen a length of the first support leg 10 when the display 200 has a large screen and a length of the mounting member 11 is insufficient.

The mounting member 11 includes a first connecting plate 111 and a first adapter plate 113 intersecting with the first connecting plate 111 at a first angle. The first connecting plate 111 has a sheet shape structure and arranged parallel to the rear surface of the display 2000, and a first connecting surface 111b is defined parallel to the rear surface of the display 2000. The first connecting surface 111b is configured for contacting and fitting with the rear surface of the display 2000.

A plurality of first connecting holes 111a are defined in the first connecting plate 111, two adjacent first connecting holes 111a are arranged side by side and spaced apart from each other along the length direction of the first support leg 10. The plurality of first connecting holes 111a are configured to attach to the display 2000 via a first fastener 80, allowing the display 2000 to be fixedly mounted on the desktop display stand 1000.

The first adapter plate 113 is bent from one side of the first connecting plate 111 and intersects the first connecting plate 111 at a first angle γ1. The first angle γ1 is 90 degrees or close to 90 degrees, that is to say, the first connecting plate 111 and the first adapter plate 113 are substantially arranged perpendicularly. A plurality of insertion holes 131 are defined in the first adapter plate 113. The plurality of insertion holes 131 are arranged side by side along the length direction of the first support leg 10 and are capable of being inserted by a second fastener 90. The plurality of insertion holes 131 of the first adapter plate 113 attach to the first support bracket 30 via the second fastener 90, so that the mounting member 11 is detachably coupled to the first support bracket 30. The first fastener 80 and the second fastener 90 can be for example screws.

The first connecting plate 111 and the first adapter plate 113 of the mounting member 11 cooperate with each other to form a receiving space 110 to receive at least a portion of the extending member 15.

The extending member 15 is configured to lengthen the length of the first support leg 10 when the length of the mounting member 11 is insufficient. A portion of the extending member 15 connected to the mounting member 11 is provided with a structure matching the shape of the mounting member 11.

The extending member 15 includes a fitting surface 153 defined on a side of the extending member 15 close to the first connecting plate 111. The fitting surface 153 and the first connecting surface 111b lie coplanarly and cooperatively fit on the rear surface of the display 2000. A plurality of extending holes 151 are defined in the fitting surface 153 of the extending member 15. The plurality of extending holes 151 are aligned with the plurality of first connecting holes 111a, and a first fastener 80 is configured to pass through the plurality of first connecting holes 111a and the plurality of extending holes 151, so that the mounting member 11 and the extending member 15 are detachably connected to each other via the first fastener 80. When the display 2000 has a large size, the first fastener 80 passes through the plurality of first connecting holes 111a of the mounting member 11, the plurality of extending holes 151 of the extending member 15, and a hole of the rear surface of the display 2000, thereby stably connecting the display 2000 to the first support leg 10. When the display 2000 has a small size, the first fastener 80 passes through the plurality of first connecting holes 111a of the mounting member 11 and the hole of the rear surface of the display 2000, allowing the mounting member 11 to engage with the rear surface of the display 2000 without using the extending member 15.

Alternatively, at least a portion of the extending member 15 is received in the receiving space 110 of the first support leg 10, and then the first connecting hole 111a, the extending hole 151 and the hole of the rear surface of the display 2000 are inserted and tightened by the first fastener 80.

The first support bracket 30 is detachably connected to the first adapter plate 113 of the mounting member 11. The first support bracket 30 has a similar triangular structure to support the first support leg 10 more stably, preventing the display 2000 from shaking on the first support leg 10.

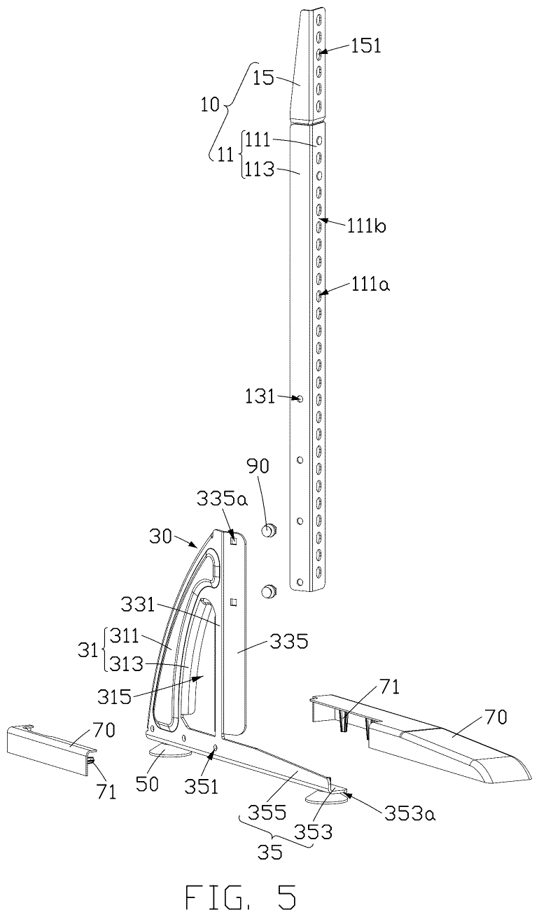

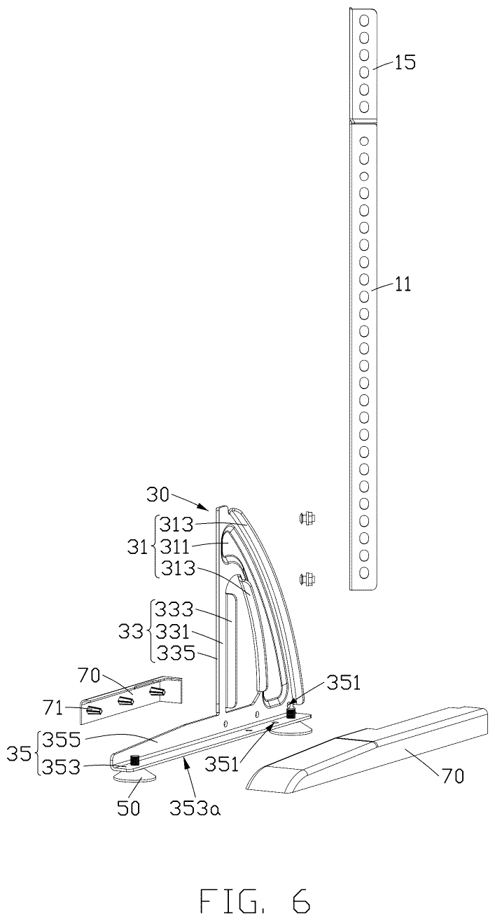

As shown in FIG. 5 and FIG. 6, the first support bracket 30 includes a grip plate 31, a connecting member 33, and a base plate 35 which are integrally formed. Two ends of the grip plate 31 connect to the connecting member 33 and the base plate 35, so as to form the similar triangular structure. In some embodiments of the present disclosure, the grip plate 31 has a curve shape to facilitate gripping by a user's hand.

The base plate 35 is placed on the desktop 3000 and has an elongated structure. The base plate 35 extends along a first direction. One end of the grip plate 31 bends upward from an end of the base plate 35, and its opposite end (away from the base plate 35) extends vertically downward to form the connecting member 33. The connecting member 33 is vertically fixedly attached to a middle position of the base plate 35, such that a part of the base plate 35 and the connecting member 33 cooperate to form a right triangular structure.

The grip plate 31 has a C-shaped structure. The grip plate 31 includes a grip rod 311 and two holding portions 313, each holding portion 313 is vertically protruded and extended from a side of the grip rod 311 to facilitate the user to grip the grip plate 31. When the user contacts the grip plate 31, fingers of the user's hand are contactable with the grip plate 31 instead of directly touching two sharp sides of the grip rod 311.

The grip plate 31 and the connecting member 33 cooperate to define a holding space 315, allowing the user's hand to be inserted into the holding space 315 to grip the grip plate 31.

Two opposite ends of the connecting member 33 are fixedly connected to the grip plate 31 and the base plate 35, respectively. The connecting member 33 is detachably connected to the first support leg 10, the first support leg 10 is supported by both the grip plate 31 and the connecting member 33, thereby enhancing a supporting capacity of the first support leg 10, especially enabling large-size displays 2000 to be stably mounted on the first support leg 10.

The connecting member 33 includes a second connecting plate 331, an anti-collision plate 333 and a second adapter plate 335. The anti-collision plate 333 and the second adapter plate 335 bend and protrude from two sides of the second connecting plate 331. One end of the second connecting plate 331 is fixedly connected to the grip plate 31, and another end of the second connecting plate 331 is fixedly connected to the base plate 35.

The anti-collision plate 333 is arranged opposite to the holding portion 313 of the grip plate 31, and is configured to prevent the user's hand from colliding with the connecting member 33 when the user's hand inserts into the holding space 315 to grip the grip plate 31. In this embodiment, the second connecting plate 331 is arranged vertically with respect to the base plate 35.

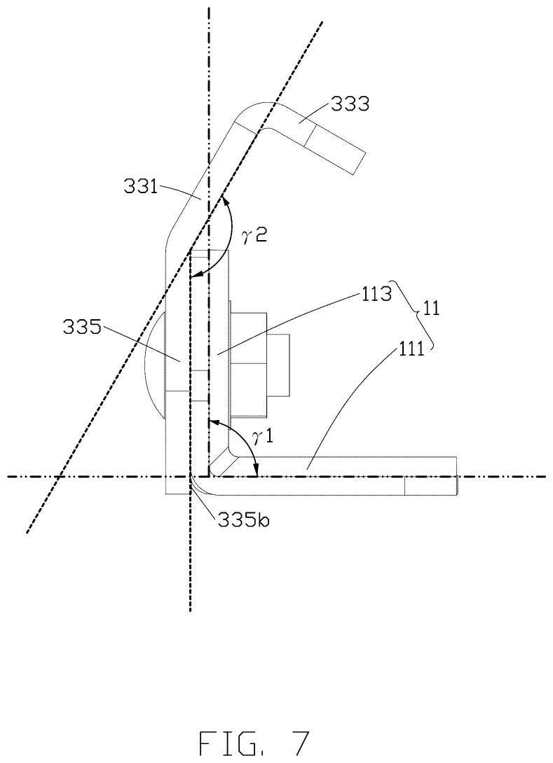

Referring to FIG. 7, the second adapter plate 335 is obliquely extended from a side of the second connecting plate 331 away from the anti-collision plate 333. The second adapter plate 335 is sheet-shaped, and an adapter surface 335b is defined thereon. The adapter surface 335b intersects the second connecting plate 331 at a second angle γ2. In this embodiment, γ2 is an obtuse angle and is larger than the first angle γ1. And an angle combination of the second angle γ2 and the first angle γ1 is configured such that the second adapter plate 335 and the first adapter plate 113 are parallel and facing each other, and an acute angle is defined between the first connecting surface 111b of the first connecting plate 111 and the second connecting plate 331.

Referring also to FIGS. 2 and 5, the second adapter plate 335 detachably connects to the first adapter plate 113 of the mounting member 11, so that an orthographic projection of the first connecting plate 111 is formed on the base plate 35 and forms a virtual extending line L2. The virtual extending line L2 intersects a virtual extending line L1 parallel to the length direction of the base plate 35 to form an inclination angle β, and the inclination angle β is an acute angle. When the second adapter plate 335 attaches to the first support leg 10 via the second fastener 90, the second adapter plate 335 and the first adapter plate 113 are arranged in parallel and facing to each other, and the second angle γ2 overlaps the first angle γ1, and the first connecting surface 111b and the second adapter plate 335 are set at an acute angle, and therefore the acute angle configuration ensures that the base plates 35 of the two stand legs are naturally arranged in an open V shape on the supporting surface 3000.

A plurality of through holes 335a are defined in the connecting member 33, and the plurality of through holes 335a correspond to and align with the plurality of insertion holes 131, so that the second fastener 90 can be inserted through both the plurality of insertion holes 131 and the plurality of through holes 335a so as to connect the first support leg 10 and the first support bracket 30.

A top end of the base plate 35 is fixedly connected to the grip plate 31. The base plate 35 has an elongate structure, and the base plate 35 is fixedly connected to the second connecting plate 331 of the connecting member 33. In some other embodiments of the present disclosure, the base plate 35 can be of any shape and structures, and may be configured as a hemispherical structure, or a wavy plate-like structure.

In this embodiment, the base plate 35 is configured as an elongated L-shaped plate. It comprises a first contact plate 353 and a first support plate 355 which are integrally formed. The first contact plate 353 is sheet-shaped and defines a first contact surface 353a, the first contact surface 353a is arranged in parallel to the supporting surface 3000 and configured for contacting with the supporting surface 3000. The first support plate 355 extends vertically upward from one side of the first contact plate 353 and is configured for connecting with the second connecting plate 331. The second stand leg 200 has a base plate 35 of the same structure as the base plate 35 of the first stand leg 100.

When the second adapter plate 335 connects to the first support leg 10, and the first support leg 10 attaches to the rear surface of the display 2000, the second adapter plate 335 is arranged in parallel to the height direction of the display 2000. In other words, after the first adapter plate 113 of the first support leg 10 fixes to the second adapter plate 335, the first connecting plate 111 faces the user. The elongated direction of the base plate 35 is obliquely arranged relative to an orthographic projection line of the second adapter plate 335. Therefore, when viewed from the front of the display 2000 to the back of the display 2000, a distance between the base plates 35 of the first stand leg 100 and the second stand leg 200 is gradually decreased, that is, orthographic projection lines of the base plates 35 of the first stand leg 100 and the second stand leg 200 are naturally arranged in an open V shape.

In detail, the virtual extending line L1 of the base plate 35 of the first stand leg 100 intersects with one end of the virtual extending line L1 of the base plate 35 of the second stand leg 200, forming an angle α. In this embodiment, the inclination angle α formed between two base plates 35 of the first stand leg 100 and the second stand leg 200 ranges from 2 degrees to 90 degrees. Preferably, the angle α between the two base plates 35 ranges from 20 degrees to 40 degrees, in this range, the distance between the base plates 35 of the first stand leg 100 and the second stand leg 200 is adapted to most large-size displays 2000, that is to say, the supporting area between the first stand leg 100 and the second stand leg 200 for the display 2000 is suitable for the large-size displays 2000, ensuring stronger stability of each display 2000 after being mounted on the stand legs 100, 200.

As shown in FIG. 6, a protective cover 70 attaches to the base plate 35. The base plate 35 is made of a metal material, and the protective cover 70 covers a surface of the base plate 35, thereby preventing the base plate 35 from being exposed to air and reacting with moisture and oxygen in the air to be corroded and rusted. In this embodiment, the protective cover 70 is made of a plastic material.

A plurality of mounting holes 351 are defined in the base plate 35. A plurality of elastic columns 71 are protruded from an inner top wall and an inner side wall of the protective cover 70 corresponding to the plurality of mounting holes 351. Each of the plurality of elastic columns 71 has an elastic structure, which is capable of elastically deforming to be inserted into and fixed in the corresponding mounting hole 351.

A pair of support feet 50 are attached or detachably attached to the base plate 35 and configured to support on the desktop 3000 and adjust a distance between the base plate 35 and the desktop 3000. Each of the pair of support feet 50 is threadedly connected to an end of the first contact plate 353 of the base plate 35 via a corresponding mounting hole 351 of the plurality of mounting holes 351. And the support foot 50 is detachable from the first stand leg 100. When the desktop 3000 is not flat or the base plate 35 needs to be elevated from the desktop 3000, the support foot 50 engages with a bottom wall of the base plate 35 to support the base plate 35.

When using the first stand leg 100 to attach a large-size display 2000, firstly, the plurality of extending holes 151 of the extending member 15 and the plurality of first connecting holes 111a of the first support leg 10 are aligned and fixed together by the first fastener 80. Next, the plurality of insertion holes 131 of the first support leg 10 and the plurality of through holes 335a of the connecting member 33 are aligned and fixed together through the second fastener 90. Then, the pair of support feet 50 are inserted into the corresponding mounting holes 351 of the base plate 35 as needed. Then, the base plate 35 is covered by the protective cover 70. Finally, the display 2000 attaches to the first connecting plate 111 of the first support leg 10 and is positioned in front of the first support leg 10, with the hole of the rear surface of the display 2000 connected to the plurality of first connecting holes 111a of the first support leg 10 via the first fastener 80.

After the desktop display stand 1000 is connected to the display 2000, the two base plates 35 of the first stand leg 100 and the second stand leg 200 are not arranged in parallel but are arranged in a splayed configuration on the supporting surface, which can adapt to large-sized displays 2000. The connection of the display 2000 on the desktop display stand 1000 is more stable and not prone to shaking. In addition, a structure of the connecting member 33 further enhances a support strength of the first support leg 10, enabling the first support leg 10 to adapt to different-sized displays 2000. After the second stand leg 200 and the first stand leg 100 are cooperatively attached to the rear surface of the display 2000, the two base plates 35 of the second stand leg 200 and the first stand leg 100 form a roughly open V shape so as to provide a supporting force to the desktop display stand 1000, ensuring the display 2000 mounted on the desktop display stand 1000 is not easy to shake, thereby providing a better viewing experience for users.

In this embodiment, the first connecting plate 111 intersects the first adapter plate 113 at a first angle γ1. The second connecting plate 331 extends vertically from the base plate 35, the second adapter plate 335 is bent from one side of the second connecting plate 331, and the second adapter plate 335 intersects the second connecting plate 331 at a second angle γ2, the second adapter plate 335 is arranged parallel and facing the first adapter plate 113 and attached to the first adapter plate 113 via the second fastener 90. When the display 2000 is supported on the supporting surface 3000 and is attached to the first connecting plate 111, the base plates 35 of the pair of stand legs 100,200 are naturally arranged in an open V shape.

### Second Embodiment

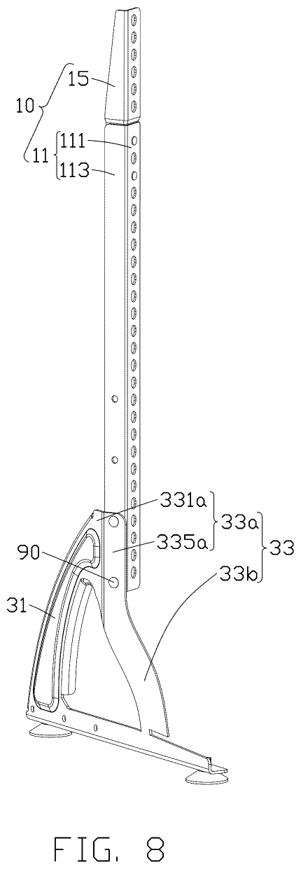

As shown in FIG. 8, reference numerals same as those in Embodiment 1 continue to be used for same elements in this embodiment. A difference between this embodiment and Embodiment 1 lies in the structure of the connecting member 33.

The connecting member 33 in this embodiment includes a first connecting member 33a and a second connecting member 33b, the first connecting member 33a extends downward from an end of the grip plate 31 (away from the base plate 35) toward the base plate 35, and the second connecting member 33b extends and bends from an end of the first connecting member 33a and attaches to the base plate 35.

The first connecting member 33a includes a second connecting plate 331a and a second adapter plate 335a. One side of the second connecting plate 331a connects to the grip plate 31, and the second adapter plate 335a bends and extends from another side of the second connecting plate 331a. The second adapter plate 335a is arranged at an acute angle relative to the second connecting plate 331a, and the second adapter plate 335a engages with the first adapter plate 113 of the mounting member 11 via the second fastener 90.

It can be understood that the shape of the second connecting member 33b may be the same as or different from that of the first connecting member 33a.

### Third Embodiment

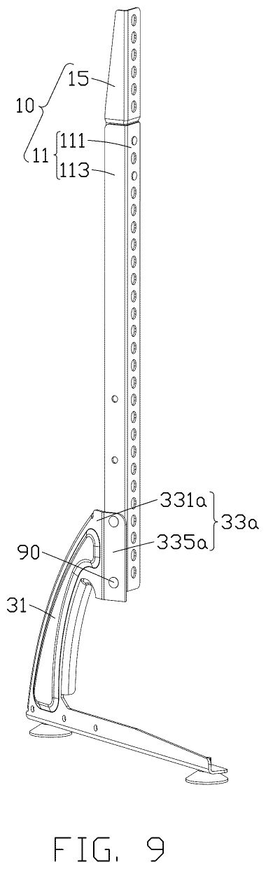

As shown in FIG. 9, reference numerals same as those in Embodiment 2 continue to be used for same elements in this embodiment. A difference between this embodiment and Embodiment 1 lies in the structure of the connecting member 33.

The connecting member 33 in this embodiment only includes a first connecting member 33a, with the second connecting member 33b being omitted.

### Fourth Embodiment

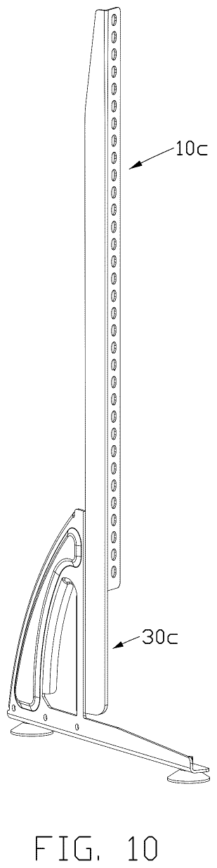

As shown in FIG. 10, reference numerals same as those in Embodiment 1 continue to be used for same elements in this embodiment. A difference between this embodiment and Embodiment 1 lies in the structure of the first support bracket 30c and the first support leg 10c.

In this embodiment, the first support bracket 30c is integrally formed with the first support leg 10c and requires no additional fastening for fixation.

What we claimed is:

1. A desktop display stand, attachable to a display and configured to support the display on a supporting surface, the desktop display stand comprising:
a pair of stand legs configured to be fixed to a rear surface of the display, each of the pair of stand legs comprising:
a first connecting plate configured to be mounted parallel to the rear surface of the display, the first connecting plate defining a first connecting surface arranged parallel to the rear surface of the display;
a first adapter plate, intersecting the first connecting surface of the first connecting plate at a first angle; and
a pair of support brackets connected to the pair of stand legs, respectively, each of the pair of support brackets comprising:
a base plate configured to be supported on the supporting surface;
a connecting member configured for connecting the base plate and the first adapter plate, the connecting member comprising a second connecting plate configured to extend from the supporting surface, and a second adapter plate intersecting the second connecting plate at a second angle,
wherein an angle combination of the second angle and the first angle is configured such that the second adapter plate and the first adapter plate are parallel and facing each other, and an acute angle is defined between the first connecting surface of the first connecting plate and the second connecting plate.

2. The desktop display stand according to claim 1, wherein the second angle is an obtuse angle, and the second angle is larger than the first angle.

3. The desktop display stand according to claim 1, wherein each of the pair of support brackets comprises a grip plate configured for gripping, one end of the grip plate extends upward from a top surface of the base plate, and another end of the grip plate is connected to the second connecting plate.

4. The desktop display stand according to claim 3, wherein the grip plate, the base plate, and the second connecting plate are integrally formed.

5. The desktop display stand according to claim 3, wherein an end of the second connecting plate away from the grip plate extends downward and attaches to the base plate.

6. The desktop display stand according to claim 5, wherein the grip plate extends in a bent manner from the base plate toward the second connecting plate,
the grip plate, the base plate, and the second connecting plate cooperate to define a holding space configured for accommodating a hand.

7. The desktop display stand according to claim 6, wherein the grip plate comprises a grip rod and two grip portions bent from two opposite sides of the grip rod toward the second adapter plate, two ends of the grip rod are fixedly connected to the second connecting plate and the base plate, respectively.

8. The desktop display stand according to claim 1, wherein a plurality of first connecting holes is defined in the first connecting plate along a length direction of the first connecting plate, the length direction is parallel to a height direction of the display, and
the first connecting plate is detachably connected to the rear surface of the display by first fasteners extending through the plurality of first connecting holes.

9. The desktop display stand according to claim 1, wherein a plurality of insertion holes is defined in the first adapter plate along the length direction of the first connecting plate,
a plurality of through holes is defined in the second adapter plate corresponding to the plurality of insertion holes,
the first adapter plate and the second adapter plate are connected to each other by second fasteners extending through the plurality of insertion holes and the plurality of through holes.

10. The desktop display stand according to claim 1, wherein each of the pair of stand legs further comprises an extending member detachably connected to an end of the first connecting plate away from the second connecting plate,
a fitting surface is defined on the extending member configured to be parallel to the rear surface of the display,
the first connecting surface and the fitting surface are co-planar and configured to be jointly attached to the rear surface of the display.

11. The desktop display stand according to claim 10, wherein the first connecting plate and the first adapter plate cooperate to define a receiving space, the receiving space is configured to accommodate at least a portion of the extending member.

12. A desktop display stand, attachable to a display and configured to support the display on a supporting surface, the desktop display stand comprising:
a pair of stand legs configured to fix to a rear surface of the display, the pair of stand legs comprising a first support leg and a second support leg which are arranged symmetrically, the first support leg comprising:
a first connecting plate configured to be arranged parallel to the rear surface of the display, the first connecting plate defining a first connecting surface configured for attaching to the rear surface of the display;
a first support bracket connected to the first support leg, a second support bracket arranged symmetrically with the first support bracket and connected to the second support leg, the first support bracket comprising:
a first base plate defining a first contact surface, the first contact surface configured to contact with the supporting surface;
a grip plate configured for gripping, one end of the grip plate extends upward from the first base plate;
a connecting member configured for connecting the first base plate, the connecting member comprising:
a second connecting plate protruded from another end of the grip plate, and extended downward toward the first base plate;
a second adapter plate bent from one side of the second connecting plate, defining an obtuse angle therebetween,
the second adapter plate attached to a side of the first connecting plate;
wherein a second base plate of the second support bracket and the first base plate of the first support bracket are naturally arranged in an open V-shape on the supporting surface when the display attaches to the pair of stand legs.

13. The desktop display stand according to claim 12, wherein the first support bracket and the first support leg are arranged integrally formed.

14. The desktop display stand according to claim 12, wherein the grip plate, the first base plate, and the connecting member are integrally formed.

15. The desktop display stand according to claim 12, wherein the second connecting plate extends downward and attaches to the first base plate.

16. The desktop display stand according to claim 15, wherein the connecting member further comprises an anti-collision plate configured for preventing the user from touching a sharp end of the second connecting plate, the anti-collision plate bends from a side of the second connecting plate away from the second adapter plate.

17. The desktop display stand according to claim 15, wherein the first base plate comprises a first contact plate configured to contact the supporting surface, the first contact surface is defined on a bottom surface of the first contact plate,
the second base plate of the second support bracket comprises a second contact plate configured to contact the supporting surface,
the display is capable of standing on the supporting surface via a cooperation of the first contact plate and the second contact plate, which are arranged in the open V-shape on the supporting surface.

18. The desktop display stand according to claim 17, wherein the first base plate further comprises a first support plate bent vertically upward from the first contact plate, and the first support plate is fixedly connected to the second connecting plate without contacting the second adapter plate.

19. The desktop display stand according to claim 18, wherein the first support bracket further comprises a support foot, one end of the support foot is contactable with the supporting surface, and another end of the support foot is detachably connected to the first contact plate to elevate a distance between the first contact plate and the supporting surface.

20. The desktop display stand according to claim 18, wherein the first support bracket further comprises a protective cover configured to cover a surface of the first base plate,
an elastic column is protruded from an inner wall of the protective cover, and a mounting hole is defined in the first base plate corresponding to the elastic column, the elastic column is deformably inserted into the mounting hole.
